(19) United States
(12) Patent Application Publication
(10) Pub. No.: US 2005/0074534 A1
(43) Pub. Date: Apr. 7, 2005

(54) Dough compositions and related methods

(76) Inventors: Douglas L. Goedeken, Blaine, MN (US); David J. Domingues, Plymouth, MN (US); John J. Fenske, Minneapolis, MN (US); Michael J. Antinone, Champlin, MN (US); Jill M. Westlund, Roseville, MN (US); Curtis M. Demulling, Minneapolis, MN (US)

Correspondence Address: KAGAN BINDER, PLLC, Maple Island Building, Suite 200, 221 Main Street North, Stillwater, MN, 55082, US

(21) Appl. No.: 10/677,029

(22) Filed: Oct. 1, 2003

(51) Int. Cl. A21D 2/00

(52) U.S. Cl. 426/551

(57) ABSTRACT

Described are dough compositions and related methods that involve proofing the dough at retarder conditions, including normally-yeast-leavened dough compositions that can be proofed at retarder conditions and then cooked without a separate proofing step between the retarder conditions and cooking.

### FIELD OF THE INVENTION

The invention relates to dough compositions that can be proofed at retarder conditions, and related methods.

### BACKGROUND

A large number of different varieties of dough compositions require a proofing step prior to cooking the dough. Proofing is a step that occurs prior to baking, which allows a dough composition to rise from a relatively dense dough to a lighter dough, for baking.

Yeast is a known dough ingredient that can produce a metabolic gas such as carbon dioxide to leaven and proof a dough composition prior to baking. Dough compositions that rely exclusively on yeast for leavening conventionally carry out proofing at room temperature or a slightly elevated temperature, but below baking temperatures. An obvious drawback of leavening a dough with yeast in this way, is that a separate and time-consuming proofing step is required before cooking. This step increases the time required to prepare a cooked dough product. On a commercial scale, proofing machines are sometimes used that hold a dough at proofing temperature for proofing. This equipment also increases the cost of preparing a proofed, yeast-leavened baked dough product.

Some dough compositions completely eliminate the proofing step by leavening a dough composition exclusively with chemical leavening agents, without yeast. The chemical leavening agents react to produce a leavening gas such as carbon dioxide. One drawback of this type of dough leavening is that chemical leavening agents often provide less desirable characteristics in a final cooked dough product, compared to yeast-leavened dough product. For example, dough products leavened exclusively by chemical leavening agents may have a less desirable taste, texture, or aroma, compared to dough products that use yeast as a leavening agent.

Dough compositions are sometimes frozen, for example, to store the dough composition for later processing or preserve dough compositions for longer periods. Many commercial frozen dough compositions, especially those that are yeast-leavened, are thawed prior to cooking at a temperature that is above freezing but below room temperature, for example, in an apparatus referred to as a retarder. For dough compositions that are unproofed and rely exclusively on yeast for leavening, such processing can add time and cost to the process of making a cooked dough product.

For efficiency, a frozen, yeast-leavened dough can be stored overnight in a retarder to allow the frozen dough to thaw. Upon thawing, the yeast-leavened dough is conventionally proofed outside of the retarder, either by placing the dough in a proof box or by exposing the dough composition to ambient conditions (i.e., “floor time”). The amount of time for proofing is substantial, and may be at least a half hour, or up to 2 or more hours

There is ongoing need to identify new, useful, or improved compositions and methods for making doughs, dough compositions, and cooked and uncooked dough products, that reduce the amount of time or cost needed to process the dough into a cooked product.

### SUMMARY

The invention generally involves dough compositions that can proof at retarder conditions. Retarder conditions are not conducive to proofing of standard yeast-leavened dough compositions. This means that after thawing in a retarder, standard yeast-leavened dough compositions do not become proofed but remain unproofed until being removed from the retarder and placed in a proofing environment. As discussed above, such a standard yeast-leavened dough composition, after thawing in a retarder, is normally exposed to proofing conditions that include room temperature or slightly higher temperature, for an extended period of time (e.g., from 30 minutes to 3 hours or longer) to cause proofing of the dough composition, e.g., in a proof box or with ambient room temperature conditions.

The dough compositions of the invention are able to leaven and proof at the temperature conditions of a retarder. Dough compositions of the invention include the types of dough compositions that are normally proofed prior to baking by the action of yeast (“normally-yeast-leavened” dough compositions). According to the invention, dough compositions of these types of yeast-leavened dough products can be formulated to be capable of being proofed at retarder conditions. After proofing at retarder conditions, the dough compositions can be cooked without a separate proofing step between the retarder conditions and cooking. “Normally-yeast-leavened” dough compositions, according to the present description, refers to dough compositions that are normally (i.e., conventionally) processed by proofing prior to baking at room temperature or at proof box conditions, wherein a volume increase of the proofing step is due substantially or only to a leavening action of yeast. Examples of normally-yeast-leavened dough compositions include dough compositions used to produce food products such as yeast-leavened rolls (e.g., cinnamon rolls), yeast-leavened breads (buns, rolls, bread sticks, etc.), yeast-leavened donuts, and other such similar dough products that are normally processed by steps including a proofing step at room temperature or slightly above (e.g., from 65 to 105° F.) prior to cooking. Normally-yeast-leavened dough compositions do not include dough compositions that are exclusively leavened by chemical leavening agents, such as chemically leavenable biscuits, cake donuts, cakes, brownies, cookies, and similar dough products that are not conventionally processed by a proofing step prior to cooking (e.g., baking or frying).

Standard, normally-yeast-leavened dough compositions will conventionally include yeast in an amount to provide leavening for proofing at room temperature or slightly above room temperature prior to cooking, and will generally not include chemical leavening agent. Normally-yeast-leavened dough compositions of the invention that can proof at retarder conditions, include yeast and chemical leavening agent (e.g., acidic active agent and basic active agent).

Methods of the invention include methods of formulating a dough composition and methods of proofing and baking. Embodiments of inventive methods include methods of formulating and proofing a normally-yeast-leavened dough composition to allow proofing of the dough composition at retarder conditions. The method of formulating includes preparing a dough composition of a type that would conventionally be leavened by yeast prior to baking, to include both yeast and chemical leavening agent so as to be capable of being proofed at retarder conditions. Embodiments of the invention involve a dough composition formulated by including yeast and chemical leavening agent into a normally-yeast-leavened dough composition, with amounts of these ingredients that are sufficient to allow the dough composition to proof at retarder conditions, especially to thaw at retarder conditions and then proof at retarder conditions.

The chemical leavening agent can preferably include an acidic active agent and a basic active agent. The acidic agent may be either a fast-acting acidic agent (e.g., relatively soluble at retarder temperature) or a slow-acting acidic agent (e.g., relatively insoluble at retarder conditions but soluble at baking conditions). Some embodiments of the dough composition can include relatively high amounts of yeast (e.g., 4 to 12 Baker's percent) in combination with a slow acting acidic active agent. Other embodiments can include a relatively lower amount of yeast (e.g., 0.5 to 4 Baker's percent) in combination with a relatively fast acting acidic active agent, and additionally, optionally and preferably, in combination with an encapsulated basic active agent.

Allowing the dough to proof in a retarder can eliminate an otherwise needed proofing step that takes place in a proof box or takes place in the open at ambient temperature (i.e., “floor time”) between the retarder and oven. Thus, exemplary embodiments of a method of the invention can be to proof a dough composition at retarder conditions (e.g., in a retarder) and bake the dough composition directly or soon after removal of the proofed dough composition from the retarder, for example within 30 minutes.

Dough compositions of the invention are typically stored frozen before they are proofed in a retarder. Therefore, the doughs can thaw as well as proof at retarder conditions. Another embodiment of the invention can include thawing a frozen dough composition at retarder conditions with subsequent proofing, also at retarder conditions. A frozen dough composition can be placed in a retarder where the dough composition thaws and proofs. The proofed dough composition can be baked directly from the retarder, or soon after, e.g., within 30 minutes from removal from retarder conditions.

Advantages that can be associated with a dough composition or method of the invention are that a dough composition that starts frozen in an unproofed state can be thawed and proofed at retarder conditions and then cooked without the delay normally associated with a separate proofing step outside of the retarder. Further, there is no requirement to transfer the dough composition out of the retarder, e.g., to a proof box or to the floor, for resting or proofing. These advantages can result in improved efficiency compared to preparation of other normally-yeast-leavened dough compositions that are removed from a retarder after being thawed, and then proofed outside of the retarder, before baking, e.g., by being placed in a proof box to expose the dough to conditions of a separate proofing step, e.g., at room temperature or a slightly elevated temperature.

An improved result overall can be to eliminate the need to transfer a dough composition from a retarder to a proof box (or ambient conditions), after thawing of the dough composition, to allow for proofing of the thawed dough composition. According to the invention, the thawed dough composition can remain in the retarder and still be proofed. This is particularly advantageous when a dough composition is thawed overnight for use when personnel arrive in the early morning. With the inventive dough compositions and methods, a dough composition can be removed from the retarder already proofed and ready to bake.

The invention can eliminate the time period required for a normally-yeast-leavened dough composition to sit for proofing between removal from a retarder and baking or frying, either by sitting in a proof box or by resting at ambient room temperature conditions. Again, in the context of a dough composition that is thawed overnight in a retarder, morning personnel do not need to wait for a thawed dough composition to proof (after removal from a retarder), but can bake the dough composition at any time, directly from the retarder.

Dough compositions and methods of the invention can also eliminate the substantial cost of equipment (e.g., a proof box, if used) and can reduce waste that can occur by use of a conventional proofing step that takes place in a proof box. Even though a proofing step can be a relatively easy and simple step, it is possible to over-proof certain dough compositions, especially if a proof box is used. Waste from such over-proofed dough can be reduced by the use of dough compositions and methods of the invention.

An aspect of the invention relates to an unproofed frozen dough composition. The composition includes leavening agent that includes yeast and chemical leavening agent that includes acidic active agent and basic active agent. The dough composition, after thawing, can proof at retarder conditions.

Another aspect of the invention relates to a method of formulating a dough composition. The method includes determining amounts of ingredients of a dough composition to result in a composition that can be stored frozen, thawed, and that can proof at retarder conditions.

Another aspect of the invention relates to a method of proofing a dough composition. The method includes providing a frozen dough composition that contains yeast and chemical leavening agent sufficient to allow the dough composition to proof at retarder conditions. The dough composition is thawed. The dough composition is exposed to retarder conditions to proof the dough composition.

The term “proofed” is used herein refers to a dough composition that has been processed by a step intended to cause a volumetric rise in the dough. For example, a “proofed” dough composition has been subject to a specific holding stage for causing the volume of the dough to increase by 50 percent or more (e.g., 50 percent to 300 percent). The raw specific volume (RSV) of a “proofed” dough composition can be in the range from about 1.5 to about 3 cubic centimeters per gram (cc/g), preferably, in the range from about 1.5 to about 2.75 cc/g, more preferably in the range from about 1.75 to about 2.5. The terms “proof” and “proofing” as used herein relate to a process intended to provide a proofed dough composition.

The term “unproofed” is used herein to refer to a dough composition that has not been processed to include any step intended to cause proofing of the dough. For example, the dough may not have been subject to a specific holding stage for causing the volume of the dough to increase by 50% or more. The raw specific volume (RSV) of an unproofed dough composition can typically be less than 1.1 cc/g, and even more typically less than 1 cc/g.

“Retarder conditions” means temperatures below room temperature (e.g., below 65° F.) at which thawing and proofing can occur. Retarder conditions can target 40° F. for thawing and, according to the invention, also for proofing. Examples of retarder conditions according to the invention can range from 32 to 46° F., sometimes from 33 to 45° F., most preferably from about 37 to 43° F.

### DETAILED DESCRIPTION

The invention relates to normally-yeast-leavened dough compositions that can be proofed at retarder conditions (e.g., in a retarder). These “normally-yeast-leavened” dough compositions are of the types of dough compositions that with standard, conventional formulations and practices, are subjected to a separate proofing step prior to baking, at a temperature that is at or slightly above room temperature, to allow yeast to proof the dough composition. Preferred such compositions and methods according to the invention allow for cooking the proofed dough composition after removal from the retarder conditions, without a separate proofing step between the retarder conditions and cooking. The dough composition can preferably be frozen in an unproofed state, thawed and proofed at the retarder conditions, and then cooked.

Generally, dough compositions for use according to the invention can be prepared from ingredients known in the dough and bread-making arts, typically including flour, a liquid component such as oil or water, and optionally additional ingredients such as shortening, salt, sweeteners, dairy products, egg products, processing aids, emulsifiers, particulates, dough conditioners, flavorants (e.g., yeast), etc. Dough compositions of the invention also include a leavening system that contains both yeast and chemical leavening agents.

Yeast can contribute to proofing of a dough composition of the invention by generating a gas (e.g., carbon dioxide) due to metabolic activity of the yeast. As used in the invention, yeast can contribute to proofing a dough composition at retarder conditions. Yeast included in the inventive dough composition may be any type of suitable yeast that can leaven and contribute to proofing a dough composition at retarder conditions. Useful yeasts that can contribute to proofing a dough composition at retarder conditions include, for example, fresh crumbled yeast (also called cake yeast or compressed yeast), yeast cream, instant dry yeast, dry active yeast, protected active dry yeast, frozen yeast, and combinations of these.

Yeast ingredients such as these can differ in the amount of moisture contained in a yeast ingredients, which can in turn influence how much of a particular yeast ingredient should be combined with other ingredients to provide a dough composition according to the invention. This selection will be readily understood by those skilled in the dough and baking arts. For example, fresh crumbled yeast (cake yeast and compressed yeast ingredients) has a higher moisture content than dry active yeast ingredient.

The moisture content of a yeast ingredient can affect the total amount of a yeast ingredient included in a dough composition. Fresh crumbled yeast, cake yeast, and compressed yeast have a moisture content of about 70% by weight of the yeast ingredient. Yeast cream typically has a higher moisture content, and dry active yeast typically has a lower moisture content, e.g., of about 8% by weight of the yeast ingredient. Thus, due to the difference in moisture content, a lower total amount of an overall dry active yeast ingredient (including less water) would likely be needed in place of a higher moisture content yeast ingredient such as fresh crumbled yeast, cake yeast, or compressed yeast. To be clear, the total amount of the yeast portion of the yeast ingredient that is added should be similar, but the amount of moisture included by adding each ingredient will differ, causing different total amounts of the ingredients to be used.

Exemplary amounts of fresh crumbled yeast that can contribute to proofing a dough composition at retarder conditions include amounts in the range from 0.5-12 parts by weight of yeast per 100 parts by weight of flour (i.e., from 0.5 to 12 Baker's percent), e.g., from 1 to 12 Baker's percent. Other yeast ingredients that have similar moisture content to fresh crumbled yeast can be used in this same range. Yeast ingredients that have different (higher or lower) percent moisture can be used in higher or lower amounts (respectively), but still in amounts that will provide the same or similar amount of the yeast component of the yeast ingredient.

The invention combines yeast and chemical leavening agent to proof a dough composition at retarder conditions. The yeast and the chemical leavening agent can both contribute to proofing at retarder conditions, optionally to different degrees depending on factors such as the amount of each type of leavening agent used and the types, especially the types of chemical leavening agents. For example, a relatively high amount of yeast may be used in a dough composition, to effect a substantial amount of yeast-leavening at retarder conditions. Relatively less chemical leavening agent may be necessary, or a slow acting chemical leavening system may be used, e.g., in the form of a slow-acting (relatively insoluble at retarder conditions) acidic agent or an encapsulated base. A slow acting acidic agent or an encapsulated base can be insoluble or un-exposed (i.e., encapsulated) at retarder conditions and become soluble or exposed to the dough at baking temperatures, where the agents can react to produce leavening gas. Alternatively, a fast acting (relatively soluble at retarder conditions) acid can provide relatively more leavening at retarder temperatures.

One exemplary embodiment of a dough composition of the invention that can proof at retarder conditions includes a dough that incorporates a relatively low amount of yeast, e.g., in the range from 1 to 4 Baker's percent, and also incorporates a chemical leavening agent that includes an acidic active agent selected to have relatively high solubility in the dough composition at retarder conditions, and a basic active agent that is encapsulated. Both the yeast and chemical leavening agent contribute to proofing the dough composition at retarder conditions, with a substantial amount of the proofing being due to the chemical leavening agent.

Another exemplary embodiment of a dough composition of the invention that can proof at retarder conditions includes a dough that incorporates a relatively high amount of yeast, e.g., in the range from 4 to 12 Baker's percent, and also incorporates a chemical leavening agent that includes an acidic active agent that has relatively low solubility in the dough composition at retarder conditions and a basic active agent that does not need to be encapsulated. Again, both the yeast and chemical leavening agent can contribute to proofing the dough composition. In this embodiment, a substantial amount of proofing at retarder conditions can be due to the yeast, with less being due to the chemical leavening agent that includes a slow-acting acidic component. The chemical leavening agents, including the slow-acting basic agent, can contribute to leavening during baking.

In other embodiments, yeast can be used with a chemical leavening system that includes a basic active agent in combination with some slow and some fast acting acidic active agents. As an example, a relatively small amount of yeast (e.g., 1-4 Baker's percent) can be used with amounts of fast acting acid to achieve a desired amount of leavening at retarder conditions, in combination with a small amount of slow acting acidic active ingredient, included to contribute toward additional leavening during baking. Alternatively, a larger portion of yeast (e.g., 4-12 Baker's percent) could be used with slow acting acidic active agent, to provide leavening at retarder conditions predominantly due to the yeast, but, an amount of fast acting acidic active agent could be included to contribute to leavening at retarder conditions.

Chemical leavening agent can include any type or combination of leavening agent understood to act as a chemical leavening agent. Generally preferred chemical leavening agents can include an acidic active agent and a basic active agent, the two of which react to produce carbon dioxide to leaven the dough composition.

Acidic active agents are generally known in the dough and bread-making arts, with some examples including leavening phosphates such as SALP (sodium aluminum phosphate), SAPP (sodium acid pyrophosphate), and monosodium phosphate, monocalcium phosphate monohydrate (MCP), anhydrous monocalcium phosphate (AMCP), and dicalcium phosphate dihydrate (DCPD); organic acids; glucono-delta-lactone; and others. Commercially available acidic active agents can include those sold under the trade names: Levn-Lite® (SALP), Pan-O-Lite® (SALP+MCP), STABIL-9® (SALP+AMCP), PY-RAN® (AMCP), and HT® MCP (MCP).

As mentioned above, acidic chemical leavening agents can be either relatively soluble (“fast-acting”) or relatively insoluble (“slow-acting) at retarder conditions. Those that are relatively soluble can dissolve at retarder conditions and can thereby enter the dough composition to react with a basic chemical leavening agent to produce carbon dioxide at retarder conditions. Those that are relatively less soluble or relatively insoluble at retarder conditions do not substantially dissolve at retarder conditions. By not substantially dissolving at retarder conditions, a slow-acting acidic leavening agent does not contribute to leavening at retarder conditions the same degree that the fast-acting acidic leavening agent does. The slow-acting acidic leavening agent will, however, contribute to leavening upon dissolution of the agent, which occurs at higher temperatures such as temperatures experienced during baking.

Acidic active agents that exhibit relatively high solubility at retarder conditions include monocalcium phosphate monohydrate, glucono-delta-lactone (GDL), anhydrous monocalcium phosphate (AMCP), potassium acid tartrate, organic acids such as fumaric, ascorbic, citric, lactic, sorbic, and propionic, and other acidic active agents that exhibit solubility behaviors similar to MCP, and GDL, or others. Acidic active agents that exhibit relatively high solubility at retarder conditions can react with basic active agent (e.g., an encapsulated basic active agent) at retarder conditions to produce carbon dioxide and contribute to proofing a dough composition at retarder conditions.

Acidic active agents that exhibit relatively low solubility in dough compositions at retarder conditions can also be referred to as “slow-acting” acids in dough compositions at retarder conditions. These acidic active agents can remain substantially undissolved (i.e., are insoluble) at retarder conditions. These acidic active agents become soluble and dissolve within a dough composition at temperatures experienced during baking, and thereby become available to react with a basic active ingredient to leaven the dough composition during baking. Acidic active agents that can exhibit relatively low solubility at retarder conditions include SALP and SAPP, dicalcium phosphate (DCP), dimagnesium phosphate (DMP), sodium aluminum sulfate (SAS), and chemical leavening agents that exhibit solubility behaviors that are similar to any of these, e.g., solubility behavior that is similar to SALP or SAPP.

Amounts of acidic active agent included in a dough composition can be any amount sufficient to neutralize an amount of basic active agent, for example an amount that is stoichiometric to the amount of basic active agent, with the exact amount being dependent on the particular acidic active agent that is chosen. The amount of acidic chemical leavening agent (and basic leavening agent) can also be selected based on the amount of yeast that is used. The total amount is used to achieve an ability of the dough composition to leaven at retarder conditions.

In certain embodiments of the invention that include acidic active agent having a relatively high solubility at retarder conditions, the “fast-acting” acidic active agent can contribute to proofing the dough composition at retarder conditions, prior to baking. The amount of such acidic active agent can be any useful amount, in combination with basic active agent and an amount of yeast, to cause desired leavening at retarder conditions. Exemplary amounts of such fast-acting acidic active agent can be from about 1 to about 5 Baker's percent, e.g., from about 1.5 to about 5 Baker's percent. The amount of yeast used in such an embodiment, e.g., fresh crumbled yeast or yeast having a similar moisture content, can preferably be in the range from 1-4 Baker's percent, e.g., 1-2 Baker's percent. Also preferred according to this embodiment is the use of encapsulated basic chemical leavening agent.

In other specific embodiments of the invention that include acidic active agent having a relatively low solubility at retarder conditions, the “slow-acting” acidic active agent can contribute less (compared to a fast-acting acidic agent) to proofing the dough composition at retarder conditions. (A substantial amount of the proofing at retarding conditions can be effected by yeast). The slow-acting acidic active agent can, however, contribute to leavening to a relatively larger extent during baking. This is because the slow-acting acidic active agent is only slightly soluble at retarder temperatures, but is substantially soluble at baking temperatures at which the acidic active agent then dissolves and can react with a basic agent to produce leavening gas. The amount of such slow-acting acidic active agent can be an amount useful, in combination with amounts of yeast and basic active agent, to cause desired leavening of a dough composition at retarder conditions. Exemplary amounts of such slow-acting acidic active agent can be from about 1 to about 5 Baker's percent, e.g., from about 1.5 to about 4 Baker's percent. The amount of yeast used in such an embodiment, e.g., fresh crumbled yeast or yeast having a similar moisture content, can preferably be in the range from 4-12 Baker's percent, e.g., 8-12 Baker's percent.

Useful basic active agents are generally known in the dough and baking arts, and include soda, i.e., sodium bicarbonate (NaHCO₃), potassium bicarbonate (KHCO₃), ammonium bicarbonate (NH₄HCO₃), etc. These and similar types of basic active agents are generally soluble in an aqueous phase of a dough composition at retarder conditions.

Basic active agent can be incorporated into a dough composition in amounts understood by those skilled in the dough and baking arts. The amount of a basic active agent to be used in a dough composition of the invention is preferably sufficient to react with the acidic active agent to release a desired amount of gas for contributing to proofing the dough composition, e.g., at retarder conditions. Exemplary amounts of basic agent can be in the range from about 0.5 to about 3 Baker's percent, e.g., from about 1.5 to about 2.5 Baker's percent.

In certain embodiments of the invention, the acidic active agent, the basic active agent, or both, may be encapsulated. In particular embodiments, an encapsulated basic chemical leavening agent can be used in combination with a fast-acting acidic chemical leavening agent to inhibit reaction of the chemical leavening agents during processing prior to the proofing step which, according to the invention, can occur at retarder conditions. Specifically, encapsulation of the basic chemical leavening agent can reduce or prevent reaction of the basic and chemical leavening agents during mixing and processing of a dough composition prior to proofing, optionally prior to freezing (followed by proofing), to allow the agents to react and proof the dough composition during a proofing step at retarder conditions. Encapsulated particles containing acidic active agent or basic active agent and barrier material are generally known, and can be prepared by methods known in the baking and encapsulation arts. An example of a method for producing encapsulated particles is the use of a fluidized bed.

The balance of the dough composition can include ingredients that contribute toward producing a dough composition that is of a type that is normally leavened by proofing with yeast prior to baking. These ingredients can include the following.

A flour component can be any suitable flour or combination of flours, including glutenous flour, nonglutenous flour, and combinations thereof. The flour or flours can be whole grain flour, wheat flour, flour with the bran and/or germ removed, or combinations thereof. Amounts of flour to be used in dough compositions are well known and can depend on the type of dough.

Examples of liquid components include water, milk, eggs, and oil, or any combination of these. Amounts of such liquid components are well known. The amount of liquid component included in any particular dough composition can depend on a variety of factors including the desired moisture content of the dough composition.

A dough composition can optionally include a fat ingredient such as oils and shortenings. Examples of suitable oils include soybean oil, corn oil, canola oil, sunflower oil, and other vegetable oils. Examples of suitable fat ingredients include animal fats and hydrogenated vegetable oils.

A dough composition can optionally include egg or dairy products such as milk, buttermilk, or other milk products, in either dried or liquid forms. Non-fat milk solids that can be used can include the solids of skim milk and may include proteins, mineral matter, and milk sugar. Other proteins such as casein, sodium caseinate, calcium caseinate, modified casein, sweet dairy whey, modified whey, and whey protein concentrate can also be used.

Dough compositions can include one or more sweeteners, either natural or artificial, liquid or dry. Examples of suitable dry sweeteners include lactose, sucrose, fructose, dextrose, maltose, corresponding sugar alcohols, and mixtures thereof. Examples of suitable liquid sweeteners include high fructose corn syrup, malt, and hydrolyzed corn syrup.

As is known, dough compositions can also optionally include other additives, colorings, and processing aids such as emulsifiers, strengtheners (e.g., ascorbic acid), preservatives, and conditioners. Suitable emulsifiers include lecithin, mono- and diglycerides, polyglycerol esters, and the like, e.g., diacetylated tartaric esters of monoglyceride (DATEM) and sodium stearoyl-2-lactylate (SSL). Flavoring agents may be included as desired, such as salt, vanilla, spices, and other natural and artificial flavorings.

A dough composition of the invention can be prepared by any of a variety of steps and methods useful in the dough and baking arts. Presently known methods, or methods developed in the future, can be useful, as will be understood. Examples of useful steps include combining and mixing ingredients such as water, flour, shortening or oil or fat, and adding in leavening agents and any other ingredients to produce a raw dough composition. The mixed dough composition can be processed by one or more steps of sheeting, folding, lapping, extruding, or otherwise shaping or forming the dough into a shape or form for packaging. Prepared dough compositions of the invention are typically frozen, and optionally stored when frozen.

Examples of packaged dough compositions of the invention include packaged, normally-yeast-leavened dough compositions such as yeast-leavened sweet rolls (including cinnamon rolls, Danishes, etc.), yeast-leavened breads (including rolls, buns, loaves, breadsticks, etc.), yeast-leavened donuts, yeast-leavened pizza doughs, etc. The dough composition, normally frozen, can be thawed and then proofed at retarder conditions, and then directly cooked (e.g., baked or fried), or cooked with only a small amount of time (e.g., 30 minutes) between removal from the retarder and cooking.

The dough composition can be packaged in any conventional package, but does not require any specific packaging or packaging environment such as a modified atmosphere, to achieve proofing at retarder conditions, or to retain good freshness. The composition does not require a package that is vented or that is flushed with any particular environment such as nitrogen or carbon dioxide. A package may be a standard flexible package of a flexible film (e.g., plastic) that contains one or more portions (e.g., loaves, rolls, etc.) either loosely or supported by a rigid structure such as cardboard or plastic. The package may be included in a larger package such as a cardboard box for sale and distribution. The package and contents may be stored frozen, and individual portions of the dough, e.g., individual rolls, can be removed and proofed. Typically, many dough portions may be removed from frozen storage at the same time, and the portions will be arranged on a tray or otherwise placed in a retarder for thawing and proofing in the retarder, according to the present invention.

Methods of the invention include methods of proofing a dough composition at retarder conditions. Dough compositions of the invention can optionally and normally be frozen after being prepared by combining ingredients, shaping, and optional packaging. In particular, a dough composition can be prepared as discussed and then frozen without allowing the dough composition to experience substantial proofing. The frozen dough composition can preferably be stored frozen, e.g., at a temperature in the range from about −10° F. to about 0° F. A frozen dough composition of the invention can be removed from frozen storage conditions and thawed and proofed at retarder conditions, e.g., in a retarder.

Examples of retarder conditions according to the invention, for proofing and optional thawing, can generally include temperatures that are above freezing (32° F.) and below room temperature (e.g., 65° F.), preferably a temperature in the range from 32-46° F. (0° C. to about 8° C.), e.g., from 33-45° C. (about 1° C. to about 7° C.), or in a range near a set point of 40° F., e.g., from about 37 to 43° F. According to the invention, proofing (e.g., to a raw specific volume of from 1.5 to 3) at retarder conditions can occur over a convenient time, such as fewer than 12 hours, e.g., fewer than 8 or 6 hours. As an example, a dough composition removed from frozen storage (e.g., having a temperature in the range from −10 to 0° F.) can thaw and proof to a RSV of at least 1.5, over a time of less than 12 hours, e.g., a time in the range from about 6 hours to about 12 hours.

Retarder conditions can be provided by commercial retarder equipment, such as a retarder apparatus or “retarder,” which is known in the dough and baking arts. The dough composition can be packaged or unpackaged during proofing (and thawing) at retarder conditions. The composition, if packaged during proofing, does not require any specific packaging or packaging environment to achieve proofing or to retain freshness, and can exclude any packaging at all, especially particular features of a package such as a carbon dioxide or nitrogen environment or a package that is vented to expel leavening gas generated during proofing.

According to embodiments of the invention, if an unproofed, dough composition is frozen, the dough composition can be exposed to retarder conditions to allow the dough composition to thaw and proof at retarder conditions. Advantageously, following thawing, the dough composition does not need to be moved (manually or otherwise) from the retarder conditions to conditions meant for proofing. The dough composition can remain in the same retarder conditions (e.g., inside of a retarder apparatus) without having to move the dough composition to expose the dough composition to conventional proofing conditions such as an extended time period at room temperature or a slightly higher temperature, such as conditions provided by a “proof box.”

Proofed dough compositions are typically cooked following proofing and removal from retarder conditions. Methods of cooking are well known in the dough and baking arts, and typically can include baking or frying for a normally-yeast-leavened dough composition. More specifically, a dough composition of the invention may be cooked by conventional means, such as being baked in an oven (e.g., conventional, convection, impingement, microwave) or fried to provide a suitable baked specific volume. Generally, a baked dough composition of the invention can have a baked specific volume in the range from about 2.5 cc/g to at least 4 or more, preferably from about 3 to about 4 cc/g.

Proofed dough compositions can be exposed to baking conditions immediately after being exposed to proofing conditions, e.g., immediately after proofing at retarder conditions is complete. In other words, a proofed dough composition of the invention can be baked without any additional floor time or proofing time outside of retarder conditions, after being proofed at retarder conditions. Optionally, if desired or needed for scheduling, the dough may thaw and then proof at retarder conditions (e.g., in a retarder), and then sit at retarder conditions for a period of time in its proofed condition. This may be necessary or desirable, for example, if a dough composition is thawed and proofed overnight and cooked in the morning. The proofed dough composition may be allowed to sit inside of a retarder apparatus after proofing for a period of time that will not negatively impact the proofed or cooked dough properties, for example up to 48 hours. At any time during that period (e.g., up to 48 hours), the dough composition can be removed from retarder conditions for cooking. This feature of the inventive composition and methods provides for very flexible scheduling of a cooking step, because the dough composition can be cooked directly from the retarder without the need for a time-consuming intermediate proofing step.

After removal from retarder conditions, a proofed dough composition can be baked directly. Alternatively, if desired, a proofed dough composition can be held for a short time after removal from retarder conditions, prior to baking. Such an optional holding time (or floor time) can be a matter of scheduling depending on factors such as the type of dough composition. For example, if a dough has been proofed at retarder conditions according to the invention, the dough composition may be wet after being exposed to retarder conditions. If so, it may be desirable to hold the dough for drying prior to frying (e.g., deep frying). This can be typical for yeast-leavened donuts and other similar dough compositions that are wet after proofing at retarder conditions and are subsequently fried. Optional floor time (i.e., holding stage) can be 30 minutes or less, preferably less than 20 minutes, and even more preferably less than 10 minutes time after removal from retarder conditions.

While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

### EXAMPLES

Examples 1-5 are dough compositions that were prepared to illustrate dough compositions that can thaw and proof at retarder conditions.

Examples 1-3 include dough compositions that include yeast, an acidic active agent selected to have relatively high solubility in the dough composition at retarder conditions, and an encapsulated basic active agent.

### Example 1

The following dough formulation includes cake yeast, glucono-delta-lactone (GDL) as an acidic active agent selected to have relatively high solubility in the dough composition at retarder conditions, and encapsulated sodium bicarbonate (BAKESURE 180 from Balchem) as an encapsulated basic active agent.

TABLE 1-A
Example 1 dough formulation

| | Parts by |
|---|---|
| Dough Ingredient | weight |
| Wheat flour | 100 |
| Water | 57.9 |
| Dextrose | 7.07 |
| Shortening | 8.93 |
| Sweet wheat solids | 2.6 |
| Salt | 1.99 |
| Mono and diglycerides | 1.93 |
| Sodium stearoyl lactylate (SSL) | 0.16 |
| Double spice | 0.27 |
| Vanilla | 0.0098 |
| Ascorbic acid | 0.02 |
| Calcium sulfate | 0.16 |
| Ammonium sulfate | 0.039 |
| L-cysteine | 0.0039 |
| Cake yeast | 4 |
| Encapsulated sodium bicarbonate | 3.24 |
| Glucono-delta-lactone (GDL) | 3.24 |

According to the above procedures, the ingredients in Table 1-A were used to make a frozen dough pieces that were then thawed and proofed in a retarder. Table 1-B, below, includes the raw specific volume as these frozen dough pieces thawed and proofed in the retarder at 40° F. (Raw specific volumes are an average of 3 pieces.)

TABLE 1-B
Raw Specific Volume as Example 1 dough thaws and proofs

| Time | Raw specific |
|---|---|
| (hours) | volume (cc/g) |
| 0 | 1.09 |
| 2 | 1.33 |
| 4 | 1.52 |
| 6 | 1.63 |
| 8 | 1.62 |
| 16 | 1.76 |
| 24 | 1.63 |
| 30 | 1.74 |

### Example 2

The following dough formulation includes cake yeast, glucono-delta-lactone (GDL) as an acidic active agent selected to have relatively high solubility in the dough composition at retarder conditions, and encapsulated sodium bicarbonate (BAKESURE 195 from Balchem) as an encapsulated basic active agent.

TABLE 2-A
Example 2 dough formulation

| | Parts by |
|---|---|
| Dough Ingredient | weight |
| Wheat flour | 100 |
| Water | 59.8 |
| Sucrose | 5.42 |
| Shortening | 7.23 |
| Cake yeast | 3.62 |
| Encapsulated sodium bicarbonate | 2.15 |
| (e-soda) | |
| Glucono delta lactone (GDL) | 2.57 |

According to the above procedures, the ingredients in Table 2-A were used to make frozen dough pieces that were then thawed and proofed in a retarder. Table 2-B, below, includes the raw specific volume as this frozen dough pieces thawed and proofed in the retarder at 40° F. (Raw specific volumes are an average of 3 pieces.)

TABLE 2-B
Raw Specific Volume as Example 2 dough thaws and proofs

| | Raw specific |
|---|---|
| Time (hours) | volume (cc/g) |
| 0 | 1.01 |
| 2 | 1.2 |
| 4 | 1.42 |
| 6 | 1.48 |
| 8 | 1.57 |
| 16 | 1.76 |
| 24 | 1.78 |
| 48 | 1.63 |

### Example 3

The following dough formulation includes cake yeast, monocalcium phosphate (MCP) as an acidic active agent selected to have relatively high solubility in the dough composition at retarder conditions, and encapsulated sodium bicarbonate (BAKESURE 193 from) as an encapsulated basic active agent.

TABLE 3-A
Example 3 dough formulation

| | Parts by |
|---|---|
| Dough Ingredient | weight |
| Wheat flour | 100 |
| Water | 57 |
| Sucrose | 5.29 |
| Shortening | 7.06 |
| Cake yeast | 3.53 |
| Encapsulated sodium bicarbonate | 2.1 |
| (e-soda) | |
| monocalcium phosphate (MCP) | 1.46 |

According to the above procedures, the ingredients in Table 3-A were used to make frozed dough pieces that were then thawed and proofed in a retarder. Table 3-B, below, includes the raw specific volume as this frozen dough pieces thawed and proofed in the retarder at 40° F. (Raw specific volumes are an average of 3 pieces.)

TABLE 3-B
Raw Specific Volume as Example 3 dough thaws and proofs

| | Raw specific |
|---|---|
| Time (hours) | volume (cc/g) |
| 0 | 0.97 |
| 2 | 1.18 |
| 4 | 1.39 |
| 6 | 1.56 |
| 8 | 1.76 |
| 16 | 1.69 |
| 24 | 1.74 |

Examples 4 and 5 include dough compositions that include a relatively high amount of yeast, an acidic active agent selected to have relatively low solubility in the dough composition at retarder conditions, and a basic active agent.

### Example 4

The following dough formulation includes yeast, SALP (sodium aluminum phospate) as an acidic active agent selected to have relatively low solubility in the dough composition at retarder conditions, and soda as a basic active agent. These dough composition exhibited proofing at retarder conditions.

TABLE 4
Example 4 dough formulation

| | Weight % | | |
|---|---|---|---|
| | based on total | | |
| | dough | Weight | |
| Dough Ingredient | formulation | (grams) | Bakers % |
| Flour | 56.25 | 8437.5 | 100 |
| Water | 30.92 | 4638 | 54.9 |
| Sucrose | 3.00 | 450 | 5.3 |
| Shortening | 4.00 | 600 | 7.1 |
| Yeast | 4.00 | 600 | 7.1 |
| Soda | 0.83 | 124.5 | 1.4 |
| sodium aluminum phosphate | 1.00 | 150 | 1.7 |
| (SALP) | | | |
| Total | 100 | 15000 | |

The ingredients in Table 4 were slowly mixed together for 60 seconds and then mixed for 6 minutes at fast speed. After mixing, dough composition was sheeted, cut, and frozen.

### Example 5

The following dough formulation includes yeast, SAPP (sodium acid pyrophosphate) as an acidic active agent selected to have relatively low solubility in the dough composition at retarder conditions, and soda as a basic active agent.

TABLE 5
Example 5 dough formulation

| | Weight % | | |
|---|---|---|---|
| | based on total | | |
| | dough | Weight | |
| Dough Ingredient | formulation | (grams) | Bakers % |
| Flour | 56.25 | 8437.5 | 100 |
| Water | 31.02 | 4653 | 55.1 |
| Sucrose | 3.00 | 450 | 5.3 |
| Shortening | 4.00 | 600 | 7.1 |
| Yeast | 4.00 | 600 | 7.1 |
| Soda | 0.83 | 124.5 | 1.4 |
| sodium acid pyrophosphate | 0.9 | 135 | 1.6 |
| (SAPP) | | | |
| Total | 100 | 15000 | |

The ingredients in Table 5 were slowly mixed together for 60 seconds and then mixed for 6 minutes at fast speed. After mixing, dough composition was sheeted, cut, and frozen.

1. An unproofed frozen dough composition comprising leavening agent comprising
yeast, and
chemical leavening agent comprising
acidic active agent, and
basic active agent,
wherein the dough composition, after thawing, can proof at retarder conditions.

2. The dough composition of claim 1 wherein the frozen dough composition can be thawed and proofed in a retarder at a temperature in the range from 32° F. to 46° F.

3. The dough composition of claim 1 wherein the yeast and chemical leavening agent can proof the dough composition at retarder conditions to a raw specific volume in a range from 1.5 to 3 cubic centimeters per gram.

4. The dough composition of claim 1 wherein the acidic active agent is selected to have relatively high solubility in the dough composition at retarder conditions and the basic active agent is encapsulated.

5. The dough composition of claim 4 wherein the acidic active agent is selected from the group consisting of monocalcium phosphate monohydrate, glucono-delta-lactone, anhydrous monocalcium phosphate, potassium acid tartrate, fumaric acid, ascorbic acid, citric acid, lactic acid, sorbic acid, propionic acid, and combinations thereof.

6. The dough composition of claim 4 wherein the yeast is present in an amount in the range from 1 to 4 parts by weight of yeast per 100 parts by weight of flour.

7. The dough composition of claim 1 wherein the acidic active agent is selected to have relatively low solubility in the dough composition at retarder conditions.

8. The dough composition of claim 7 wherein acidic active agent is selected from the group consisting of sodium aluminum phosphate, sodium acid pyrophosphate, dicalcium phosphate, dimagnesium phosphate, sodium aluminum sulfate, and combinations thereof.

9. The dough composition of claim 7 wherein the yeast is present in an amount in the range from 4 to 12 parts by weight of yeast per 100 parts by weight of flour.

10. The dough composition of claim 1 wherein the dough composition comprises a normally-yeast-leavened dough composition.

11. The dough composition of claim 10 wherein the normally-yeast-leavened dough composition is selected from the group consisting of a yeast-leavened cinnamon roll, a yeast-leavened roll, a yeast-leavened bread, and a yeast-leavened donut.

12. A method of formulating a dough composition, the method comprising determining amounts of ingredients of a dough composition to result in a composition that can be stored frozen, thawed, and that can proof at retarder conditions.

13. A method of proofing a dough composition, the method comprising
providing a frozen dough composition comprising yeast and chemical leavening agent sufficient to allow the dough composition to proof at retarder conditions,
thawing the dough composition, and
exposing the dough composition to retarder conditions to proof the dough composition.

14. The method of claim 13 comprising thawing and proofing the dough composition in a retarder.

15. The method of claim 13 wherein the dough composition proofs to a raw specific volume in a range from 1.5 to 3 cc/g.

16. The method of claim 13 comprising
placing the frozen dough composition in a retarder,
allowing the frozen dough composition to thaw while in the retarder, and
allowing the frozen dough composition to proof while in the retarder to a raw specific volume in a range from 1.5 to 3 cc/g.

17. The method of claim 16 wherein
the frozen dough composition thaws and proofs over a period of time in the range from about 6 hours to about 12 hours inside of the retarder, and
the retarder conditions comprise a temperature in a range from about 32° F. to about 46° F.

18. The method of claim 12 wherein the dough composition comprises
acidic active agent selected from sodium aluminum phosphate and sodium acid pyrophosphate, and
from 4 to 12 parts by weight yeast per 100 parts by weight of flour.

19. The method of claim 12 wherein the dough composition comprises
acidic active agent selected from monocalcium phosphate monohydrate and glucono-delta-lactone, and
from 1 to 4 parts by weight yeast per 100 parts by weight of flour.

20. The method of claim 12 comprising allowing the proofed dough composition to rest for a period of 30 minutes or less at about room temperature between removing the proofed dough composition from retarder conditions and cooking the proofed dough composition.
